(19) United States
(12) Patent Application Publication
(10) Pub. No.: US 2016/0379230 A1
(43) Pub. Date: Dec. 29, 2016

(54) SYSTEM, DEVICE, AND METHOD FOR MAKING AUTOMATIC CALLS

(71) Applicant: ALIBABA GROUP HOLDING LIMITED, George Town (KY)

(72) Inventor: Dong CHEN, Hangzhou (CN)

(73) Assignee: ALIBABA GROUP HOLDING LIMITED

(21) Appl. No.: 15/190,662

(22) Filed: Jun. 23, 2016

(30) Foreign Application Priority Data
Jun. 25, 2015 (CN) 201510357804.1

(51) Int. Cl. G06Q 30/02; G10L 15/08; H04M 3/51

(52) U.S. Cl. CPC G06Q 30/0203; H04M 3/5158; G10L 15/083; G10L 2015/088

(57) ABSTRACT

A method for making automatic calls is disclosed. The method includes: when a user order status is a target order status, acquiring a set of target audio files corresponding to the target order status and a user phone number included in recipient contact information in the user order, each of the target audio files corresponding to a question in a survey; sending a call instruction including the user phone number to an interactive audio answering sub-system, the call instruction prompting the interactive audio answering sub-system to call to a terminal corresponding to the user phone number; and after receiving a returned response from the interactive audio answering sub-system indicating a connection to the terminal is established, sending a broadcast instruction to an audio broadcasting sub-system to play the set of target audio files.

### CROSS-REFERENCE TO RELATED APPLICATIONS

This application is based upon and claims priority to Chinese Patent Application No. 201510357804.1, filed Jun. 25, 2015, the entire contents of which are incorporated herein by reference.

### TECHNICAL FIELD

The present disclosure generally relates to the field of communications technology, and more particularly, to a system, device, and method for making automatic calls.

### BACKGROUND

Electronic commerce (E-commerce) platforms, such as, Taobao, Tmall, Amazon, etc., has been growing dramatically. Today after a user completes a transaction on an E-commerce platform, the E-commerce platform sends the user a survey to understand how satisfactory the user is using the platform to purchase items and acquire a rating on the user's experience. The E-commerce platform may use the user rating to improve it services and user experiences, increase its competitiveness, and win customer resources.

In the related art, an E-commerce platform conducts a user survey after the user sends a message to the E-commerce platform indicating receipt of the ordered goods or services, by displaying a survey to the user. If the user voluntarily provides comments to the inquiries of the survey, the E-commerce platform can acquire user ratings from the returned survey.

However, in the related art, it is only after the user confirms receipt of goods on line can the E-commerce platform sends the survey to the user to acquire user ratings. If the user never confirms the receipt of goods on line, the E-commerce platform would not be able to send the survey to the user.

Thus, in the related art, whether the E-commerce platform can send a survey to a user depends on whether the user confirms receipt on line. This reduces the possibility to send surveys to users and acquire user ratings via user surveys.

### SUMMARY

Consistent with embodiments of the present disclosure, there is provided a method for making automatic calls. The method is performed by a controller and includes: when a user order status is a target order status, acquiring a set of target audio files corresponding to the target order status and a user phone number included in recipient contact information in the user order, the set of target audio files including one or more audio files, each of the target audio files corresponding to at least one question in a survey; sending a call instruction including the user phone number to an interactive audio answering sub-system, the call instruction prompting the interactive audio answering sub-system to call to a terminal corresponding to the user phone number; and after receiving a returned response from the interactive audio answering sub-system indicating a connection to the terminal is established, sending a broadcast instruction to an audio broadcasting sub-system to play the set of target audio files. In some embodiments, the returned response is generated and forwarded by the terminal after the terminal answers the call.

Consistent with embodiments of the present disclosure, there is provided a method for making automatic calls. The method is performed by an interactive audio answering sub-system and includes: receiving a call instruction including a user phone number and making a phone call to a terminal corresponding to the user phone number, the call instruction being generated by a controller when a user order status is a target order status, the controller acquiring a set of target audio files corresponding to the target order status and the user phone number included in recipient contact information in a user order, the set of target audio files including one or more audio files, each of the target audio files corresponding to at least one question in a survey; sending a response to the controller indicating a connection to the terminal is established after the terminal accepts the phone call; and transmitting a set of target audio files to the terminal after an audio broadcasting sub-system responds to a broadcast instruction, the broadcasting instruction being forwarded by the controller to the audio broadcasting sub-system. In some embodiments, the broadcasting instructions are forwarded after the controller receives the response from the interactive audio answering sub-system.

Consistent with embodiments of the present disclosure, there is provided a method for making automatic calls. The method is performed by an audio broadcasting sub-system and includes: receiving a broadcast instruction from a controller to play a set of target audio files, the broadcasting instruction being generated by the controller when a user order status is a target order status, the broadcast instruction being sent by the controller after the controller acquires a set of target audio files corresponding to the target order status and the user phone number included in recipient contact information in a user order, sends a call instruction to an interactive audio answering sub-system, and receives a response from the interactive audio answering sub-system indicating that a connection to a terminal corresponding to the user phone number is established, the set of target audio files including one or more audio files, each of the target audio files corresponding to at least one question in a survey, the call instruction prompting the interactive audio answering sub-system to make a phone call to the terminal corresponding to the user phone number; and playing the set of target audio files, wherein the played target audio files are acquired and transmitted by the interactive audio answering sub-system to the terminal.

Consistent with embodiments of the present disclosure, there is provided a system for making automatic calls. The system includes a controller, an audio broadcasting sub-system and interactive audio answering sub-system coupled to the controller, and a terminal coupled to the interactive audio answering sub-system. The audio broadcasting sub-system and the interactive audio answering sub-system are coupled to each other. The controller is configured to, when a user order status is a target order status, acquire a set of target audio files corresponding to the target order status and a user phone number included in recipient contact information in the user order, send a call instruction including the user phone number to the interactive audio answering sub-system, and sends a broadcast instruction to the audio broadcasting sub-system to play the set of target audio files after receiving a returned response from the interactive audio answering sub-system indicating a connection to the terminal is established, the set of target audio files including one or more audio files, each of the target audio files corresponding to at least one question in a survey. The interactive audio answering sub-system is configured to receive the call instruction and make a phone call to the terminal corresponding to the user phone number, send the response to the controller after the terminal accepts the phone call, and transmit the set of target audio files to the terminal after the audio broadcasting sub-system responds to the broadcast instruction to play the set of target audio files. The audio broadcasting sub-system is configured to receive the broadcast instruction sent by the controller and play the set of target audio files.

Consistent with embodiments of the present disclosure, there is provided a device for making automatic calls. The device includes: a data acquiring unit configured to, when a user order status is a target order status, acquire a set of target audio files corresponding to the target order status and a user phone number included in recipient contact information in the user order, the set of target audio files including one or more audio files, each of the target audio files corresponding to at least one question in a survey; a sending unit configured to send a call instruction including the user phone number to an interactive audio answering sub-system, the call instruction prompting the interactive audio answering sub-system to call to a terminal corresponding to the user phone number; a broadcasting unit configured to, after receiving a returned response from the interactive audio answering sub-system indicating a connection to the terminal is established, send a broadcast instruction to an audio broadcasting sub-system to play the set of target audio files. In some embodiments, the returned response is generated and forwarded by the terminal after the terminal answers the call.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a block diagram of an exemplary system for making automatic calls, consistent with embodiments of the present disclosure.

FIG. 2A is a flow chart showing an exemplary method for making automatic phone calls, consistent with embodiments of the present disclosure.

FIG. 2B is a flow chart illustrating further steps in step S201 shown in FIG. 2A.

FIG. 3 is a flow chart showing a method for acquiring vocal files, consistent with embodiments of the present disclosure.

FIG. 4 is a flow chart showing a method for determining user ratings based on vocal files, consistent with embodiments of the present disclosure.

FIG. 5 is a flow chart showing a method for storing and outputting the user ratings, consistent with embodiments of the present disclosure.

FIG. 6 is a flow chart illustrating another method for making automatic phone calls, consistent with embodiments of the present disclosure.

FIG. 7 is a flow chart illustrating another method for making automatic phone calls, consistent with embodiments of the present disclosure.

FIG. 8 is a block diagram showing an exemplary controller for making automatic phone calls, consistent with embodiments of the present disclosure.

FIG. 9 is a block diagram illustrating configurations of the data acquiring unit 81 shown in FIG. 8.

FIG. 10 is a block diagram illustrating configurations of the broadcasting unit 83 shown in FIG. 8.

FIG. 11 is a block diagram showing another exemplary controller for making automatic phone calls.

FIG. 12 is a block diagram showing exemplary configurations of the result-determining unit 112 shown in FIG. 11.

### DETAILED DESCRIPTION

An E-commerce platform may use phone operators to orally convey questions in the survey to users and listen to user answers to the questions so as to acquire user ratings. For example, a phone operator can orally read the questions in the survey to a user and acquire user ratings. The survey conducted with the above method does not depend on whether the user confirms receipt of purchased goods on line and reduces the reliance on user actions.

But the quantity of user orders on the present E-commerce platforms is tremendous. If the surveys are conducted by operators for the orders, the operators need to frequently dial out to the users to acquire user answers to the survey. The efficiency of such a process is lower. In addition, the method needs many operators in dialing out to the users, increasing the cost of the E-commerce platforms.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Before the detailed methods and devices consistent with embodiments of the present disclosure are explained, a system for automatically dialing out to users is described below. The system may facilitate one of ordinary skill in the art to understand the environment to which the present disclosure is directed.

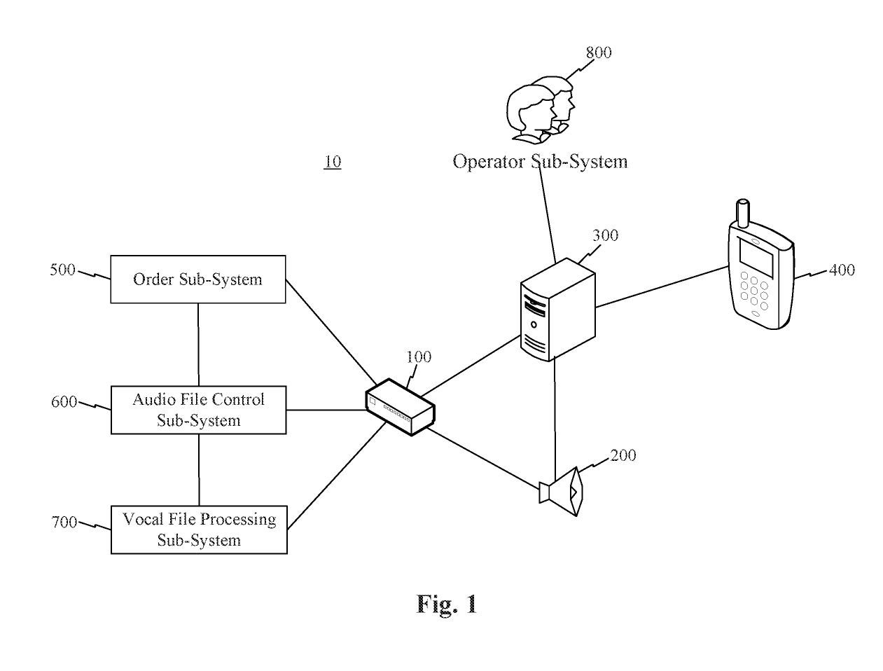

FIG. 1 is a block diagram of an exemplary system 10 for making automatic calls.

Referring to FIG. 1, the system 10 includes a controller 100, an audio broadcasting sub-system 200 and an interactive audio answering sub-system 300 coupled to the controller 100, and a terminal 400 coupled to the interactive answering sub-system 300. In one embodiment, the audio broadcasting device 200 is coupled to the interactive answering sub-system 300.

In one embodiment, the system 10 further includes an order sub-system 500 of an E-commerce merchant coupled to the controller 100, an audio file control sub-system 600 coupled to the controller 100, a vocal file processing sub-system 700 coupled to the controller 100, and an operator sub-system 800 coupled to the interactive answering sub-system 300.

Consistent with embodiments of the present disclosure, the system 10 for making automatic calls automatically broadcasts audio survey to the users. In some embodiments, before broadcasting an audio survey to the users, one or more audio files of the survey are pre-recorded. Steps of recording the audio files of the survey are explained below.

A user order may be in multiple statuses, such as a status of awaiting payment, awaiting the user to receive goods, or awaiting the user to confirm receipt of purchased items. The user may have different user experiences in each of the order statuses. The present disclosure will focus on the user experience in one of the important statuses as an example to explain the concept of the present disclosure. The present disclosure also provides methods of generating surveys for acquiring user rating corresponding to each of the order statuses. Each of the surveys may include one or more questions. For example, a first survey is generated for acquiring user experiences in the status of awaiting payment; a second survey is generated for acquiring user experiences in the status of awaiting the user to receive goods; and a third survey is generated for acquiring user experiences in the status of awaiting the user to confirm receipt of purchased goods.

A survey corresponding to an order status of interest (target order status) may include a set of audio files of interest (target audio files). In one embodiment, a survey of a target order status may include one or more questions. A technical person can record the questions to form audio files, which can be used to generate a set of audio files corresponding to the survey. Based on these steps, each of the surveys, including a set of pre-recorded audio files that corresponds to each of the target order statuses, can be generated.

A system for making automatic calls consistent with embodiments of the present disclosure can simultaneously process multiple user orders. In some embodiments, the processing of each of the user orders is consistent with and similar to each other. Thus, the following embodiments are provided to describe generating automatic calls with respect to one single user order. The present disclosure, however, is not so limited and can be applied to processing multiple user orders.

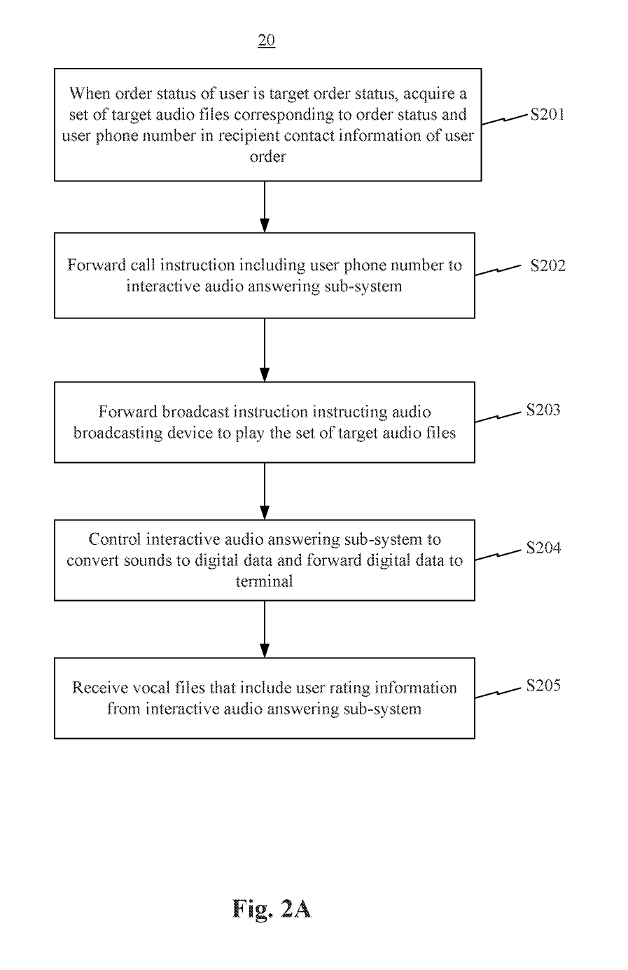

FIG. 2A is a flow chart showing an exemplary method 20 for making automatic phone calls. The method 200 can be performed by, for example, the controller 100 of the system 10 for making automatic calls, shown in FIG. 1. Referring to FIG. 2A, method 20 includes steps S201-S203.

In step S201, when the user order status is the target order status, the controller 100 acquires a set of target audio files corresponding to the target order status and user phone number included in recipient contact information in the user order. The set of target audio files includes one or more audio files. In one embodiment, each of the audio files corresponds to at least one question in the survey.

FIG. 2B is a flow chart illustrating further steps in step S201 shown in FIG. 2A. Referring to FIG. 2B, the step S201 may further include steps S2011, S2012, and S2013. In step 2011, the controller 100 determines that the user order status is the target order status. In step S2012, the controller 100 acquires target audio files corresponding to the order status. In step S2013, the controller 100 acquires the user phone number included in the recipient contact information of the user order.

The controller 100 may determine that the user order status is the target order status in step S2011 based on, for example, the following methods.

In one embodiment, the controller 100 may use the order sub-system 500 to determine that the user order status is the target order status. After the user makes an order, the order sub-system 500 generates a user order including an order identification and order status. The order identification is unique and can be used to unequivocally identify the user order. The order status is changeable. For example, when user makes the order without payment, the order status may be shown as “awaiting payment.” When the user makes payment but the merchant has not delivered the purchased item, the order status may be shown as “awaiting delivery.”

Because the order status changes over time, the controller 100 consistent with embodiments of the present disclosure can monitor the order status in the order sub-system 500. When the order status is changed to the target order status, the controller 100 determines that the order status is the target order status.

In one embodiment, the controller 100 receives a confirmation message sent by the order sub-system 500 to determine that the order status is the target order status. The order sub-system 500 monitors the order status as it changes over time. When the order sub-system 500 detects that the order status is changed to the target order status, it forwards a confirmation message to the controller 100 so that the controller 100 can determine that the order status is changed to the target order status.

In one embodiment, the controller 100 receives a confirmation message from other order-status monitoring devices to determine that the order status is the target order status. The order sub-system 500 can forward the order status to another monitoring device. When the monitoring device detects that the order status is changed to the target order status, it forwards a confirmation message to the controller 100 so that the controller 100 can determine that the order status is changed to the target status.

The present disclosure provides the above three methods in which the controller 500 can determine that the order status is the target order status. However, the controller 500 may employ other methods to make the determination and is not limited to the above embodiments.

The controller 100 may acquire target audio files corresponding to the order status in step S2012 based on, for example, the following methods.

In one embodiment, the controller 100 may acquire the target audio files within itself. The controller 100 or other devices may establish a set of target audio files for each of the user surveys, and store each target order status and a corresponding set of target audio files in a storage unit of the controller 100 or a storage device (not shown) connected to the controller 100.

After the controller 100 determines that the order status is the target order status in step S2011, it searches and determines a set of target audio files corresponding to the target order status in the storage unit of the controller 100 or the storage device.

In another embodiment, the controller 100 may acquire target audio files sent from another device. The controller 100 or another device (e.g., order sub-system 500) may establish a set of target audio files for each of the user surveys, and store each target order status and a corresponding set of target audio files in the device. The device may acquire target order status sent by the controller 100, from the order sub-system 500, or by detecting or monitoring by itself the order status to know that the order status is changed to the target order status. After the device confirms that the order status is the target order status, it searches its own storage unit to find a set of target audio files corresponding to the target order status. The device then forwards the set of target audio files to the controller 100.

Consistent with embodiments of the present disclosure, the controller 100 may employ other methods to confirm that the order status is the target order status.

In some embodiments, the controller 100 may acquire the user phone number included in the recipient contact information in the user order in step S2013 based on, for example, the following methods.

In one embodiment, the controller 100 acquires the user phone number from the order sub-system 500. In addition to order identification and order status, an order may further include contact information of the recipient. Generally, the recipient contact information includes the phone number of the user. After the controller 100 acquires the recipient information on the order, it can acquire the user phone number.

In the illustrated embodiment above, the controller 100 needs to exchange information with the order sub-system 500 in order to acquire the user phone number. In some embodiments, the order sub-system 500 may acquire the user phone number, and store the phone number and corresponding order identification in the controller 100 and a storage device connected to the controller 100. The controller 100 can search its storage unit or the connected storage device to acquire the user phone number to reduce data exchange with the order sub-system 500.

In one embodiment, the controller 100 may acquire the user phone number from itself or a storage device (not shown) connected to the controller 100. The controller 100 can search for the order identification in its storage unit or the connected storage device. If the controller 100 can find the order identification, then the user phone number and the corresponding order identification are stored locally. The controller can acquire the user phone number by searching the order identification. This method does not involve data exchange with the order sub-system 500 so that the search can be performed relatively quickly. If the search fails to find the order identification, the controller 100 reaches out to the order sub-system 500 to acquire the user phone number.

Referring again to FIGS. 1 and 2A, in step S202, the controller 100 forwards a call instruction including the user phone number to the interactive audio answering sub-system 300. The call instruction prompts the interactive audio answering sub-system 300 to make a phone call to a terminal 400 corresponding to the user phone number.

After acquiring the user phone number and the set of target audio files, the controller 100 controls to transmit the target audio files to the terminal corresponding to the user phone number to automatically broadcast the survey to the user.

In the illustrated embodiment, the controller 100 forwards a call instruction including the user phone number to the interactive audio answering sub-system 300, which make a phone call to the terminal corresponding to the user phone number in response to the call instruction. After the user answers the phone call via the terminal 400, the interactive audio answering sub-system 300 returns a response to the controller 100 indicating that a connection to the terminal 400 is established.

In step S203, after receiving the returned response from the interactive audio answering sub-system 300, the controller 100 sends a broadcast instruction to the audio broadcasting sub-system 200 to play the set of target audio files. After the audio broadcasting sub-system 200 plays the set of target audio files, the interactive audio answering sub-system 300 receives and transmits the audio files to the terminal 400.

In one embodiment, after receiving the returned response from the interactive audio answering sub-system 300, the controller 100 controls the audio broadcasting sub-system 200 to play the set of target audio files, which generates sounds. In some embodiments, referring to FIGS. 1 and 2A, in step S204, the controller 100 controls the interactive audio answering sub-system 300 to convert the sounds to digital data and forward the digital data to the terminal 400. The terminal 400 receives the digital data transmitted from the interactive audio answering sub-system 300 and processes the digital data to play the audio files, so that the user may listen to the audio questions of the survey.

In the illustrated embodiment, the controller 100 may initiate automatic calls to the user based on the order status and forwards the survey to the user by way of playing the audio files. The order status of the user prompts the controller 100 to send the survey to the user. Because order status does not depend on the user confirming receipt of the order, the methods consistent with embodiments of the present disclosure can acquire user ratings with high probability without relying on the user's action to confirm receipt of the order. Further, the conventional art uses text format to distribute the survey. The methods consistent with embodiments of the present disclosure conduct the survey by playing audio files to the user, which improves the user experience with the survey.

The conventional art uses a phone operator to orally read the survey to the user. A controller consistent with embodiments of the present disclosure can control to automatically play the survey to the user and is more efficient than a phone operator. Further, even when user orders increases a great deal, there is no need to increase the number phone operators to conduct the survey, which saves the cost of E-commerce merchants. The methods consistent with embodiments of the present disclosure can improve efficiency in conducting user survey without adding cost.

After the audio files are played to the user, in some embodiments, the method of the present disclosure further acquires user responses to the questions of the survey. In one embodiment, the controller 100 controls the audio broadcasting sub-system 200 to play the set of target audio files. The controller 100 controls the interactive audio answering sub-system 300 to transmit the target audio files to the terminal 400 and to receive vocal files that include user rating information.

The user rating information is the user responses to the survey questions transmitted to the terminal 400 after the user listens to the target audio files corresponding to the questions of the survey. In some embodiments, each of the vocal files corresponds to a target audio file. Because one vocal file corresponds to one audio file, if a set of target audio files includes only one audio file, a set of vocal files includes only one vocal file.

In one embodiment, the step of the interactive audio answering sub-system 300 receiving user ratings including vocal files are explained below. The controller 100 controls the audio broadcasting sub-system 200 to play the target audio files and the interactive audio answering sub-system 300 to transmit the target audio files to the terminal 400. Referring to FIGS. 1 and 2A, in step S205, the controller 100 receives vocal files that include user rating information from the interactive audio answering sub-system 300.

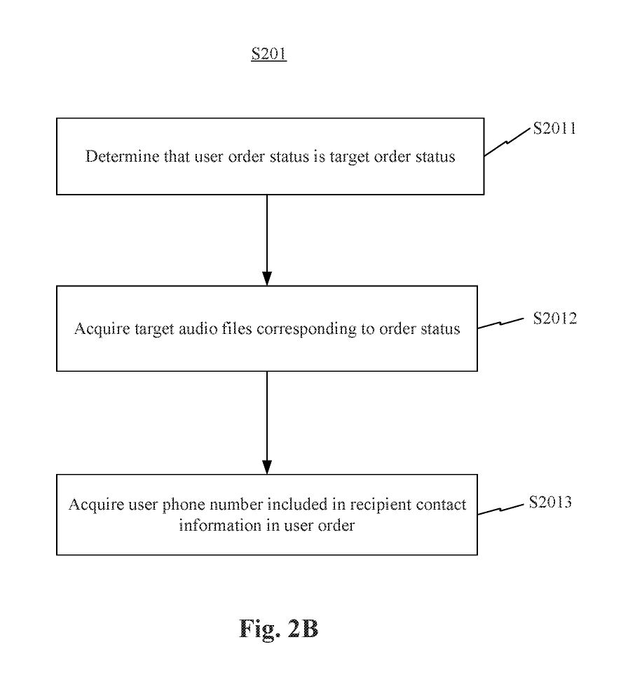

FIG. 3 is a flow chart showing a method 30 performed by the controller 100 for acquiring vocal files that include user rating information from the interactive audio answering sub-system 300. Referring to FIG. 3, method 30 includes steps S301-S304.

In step S301, the controller 100 determines a current audio file from a set of target audio files that has not been played. The set of target audio files includes a plurality of audio files, each of which corresponds to a question of the survey. The target audio files may be lined up according to the sequential order of the questions. In one embodiment, the controller 100 controls to play the target audio files to the user based on the sequential order of the questions on the survey. The controller 100 selects the first one of the un-played audio files to be the current audio file. The current audio file is the next one to be played to the user.

In step S302, the controller 100 forwards a broadcast instruction to the audio broadcasting sub-system 200, instructing the audio broadcasting sub-system 200 to play the current audio file.

In one embodiment, the controller 100 sends an instruction to the audio broadcasting sub-system 200, which controls the audio broadcasting sub-system 200 to play the current audio file. The interactive audio answering sub-system 300 receives and transmits the audio file to the terminal 400.

In step S303, the controller 100 receives a vocal file (current vocal file) corresponding to the current audio file within a predetermined time period.

In one embodiment, the controller 100 starts a timer after it controls to play the current audio file. If the controller 100 receives a vocal file corresponding to the current audio file within a predetermined time period after the timer starts, it indicates that user responds to the question corresponding to the current audio file.

If the controller 100 does not receive a vocal file corresponding to the current audio file within a predetermined time period, it indicates that user does not respond to the question corresponding to the current audio file, or that transmitting the vocal file to the controller 100 fails. The controller 100 controls to re-play the current audio file. If the controller 100 fails to receive a vocal file after re-playing the current audio file, it repeats the above steps to have the current audio file played until the number of re-play equal to a predetermined number.

When the number of re-playing the current audio file reaches the predetermined number and the controller 100 still fails to receive a corresponding vocal file, it is possible that the current audio file is damaged, the system for making automatic calls fails, or the terminal on the user side fails. Under these circumstances, it is in vain to continue playing the current audio file to the user, and the controller 100 stops re-playing the current audio file.

In one embodiment, after the controller 100 stops re-playing the current audio file, it may execute the next step to play another audio file or send an instruction to the interactive answering sub-system 300 to control the interactive answering sub-system 300 to switch to the operator sub-system 800. This switches the automatic system to a manual system where the survey is conducted by a customer service representative.

In step 304, the controller 100 determines whether the set of target audio files include un-played audio files. If there is an un-played audio file, the method 30 returns to step S301. If the controller 100 determines that there is no un-played audio file, the method 30 ends.

In some embodiments, after acquiring a set of vocal files according to method 30 shown in FIG. 3, methods consistent with embodiments of the present disclosure further include determining user ratings based on the received vocal files. The user ratings may be determined manually. But it is less efficient to determine user ratings manually. The present disclosure further provides methods for determining user ratings by computers.

In one embodiment, the controller 100 may forward the vocal files to a vocal file processing sub-system 700 shown in FIG. 1. The vocal file processing sub-system 700 executes steps to determine user ratings based on the vocal files. After acquiring the user ratings corresponding to the vocal files, the vocal file processing sub-system 700 returns the user rating information to the controller 100. In one embodiment, the controller 100 may execute steps to determine user ratings based on the vocal files to acquire the user ratings.

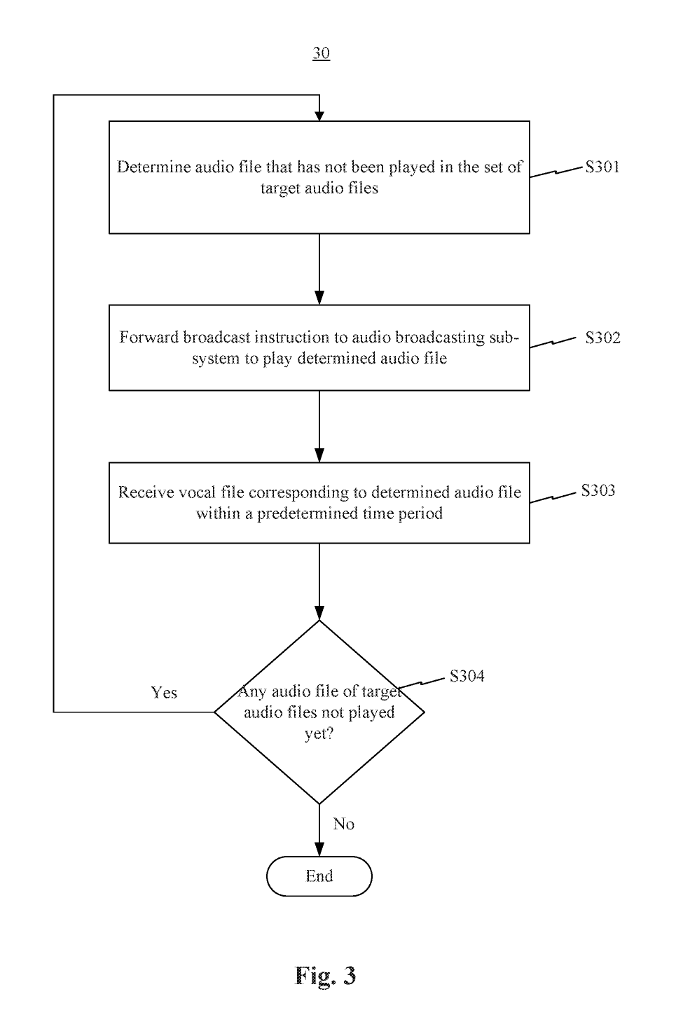

FIG. 4 is a flow chart showing a method 40 for determining user ratings based on vocal files. The method 40 may be applied to each of the vocal files to obtain a corresponding user rating. Method 40 may be performed by the controller 100 or the vocal file processing sub-system 700. Referring to FIG. 4, the method 40 includes steps S401-S403.

In step S401, a device (the controller 100 or the vocal file processing sub-system 700) is configured to recognize the sounds of a vocal file to acquire one or more key words that can be used to indicate user ratings from the vocal file.

In one embodiment, the vocal file is recognized and converted to a text file. The device is configured to extract target key words that indicate the user ratings. Exemplary target key words include “satisfied,” “very satisfied,” dissatisfied,” or “very dissatisfied,” etc.

In step S402, the device is configured to compare the target key words with predetermined key words.

In one embodiment, the predetermined key words includes a first set of key words (first key words) indicating satisfactory and a second set of key words (second key words) indicating dissatisfactory.

For example, the controller 100 compares the target key words acquired from the vocal file with the first key words. If there is a match, the target key words are determined to correspond to the first key words. The match with the first key words indicates that the user is satisfied with purchase experience.

The controller 100 compares the target key words acquired from the vocal file with the second key words. If there is a match, the target key words are determined to correspond to the second key words. The match with the second key words indicates that the user is dissatisfied with purchase experience.

If the target key words match neither the first key words nor the second key words, it is determined that the user does not provide a user rating or that the target key words the user chooses to use is not included in the predetermined key words. In this case, the device is configured to notify the system administrator to employ the operator sub-system 800 to manually determine the user rating.

In step S403, when the target key words match the predetermined key words, the device is configured to determining user ratings corresponding to the target key words.

In one embodiment, when the target key words match the first key words, user ratings are determined to be a first result, which indicates that the user is satisfied with purchase experience.

When the target key words match the second key words, user ratings are determined to be a second result, which indicates that the user is dissatisfied with purchase experience.

In some embodiments, when the user ratings are the second result, the device is configured to generate complaint information to inform the E-commerce merchant that the user is dissatisfied with purchase experience. In one embodiment, the device is configured to inform the system administrator to use operator sub-system 800 to manually deal with the user's dissatisfactory purchase experience.

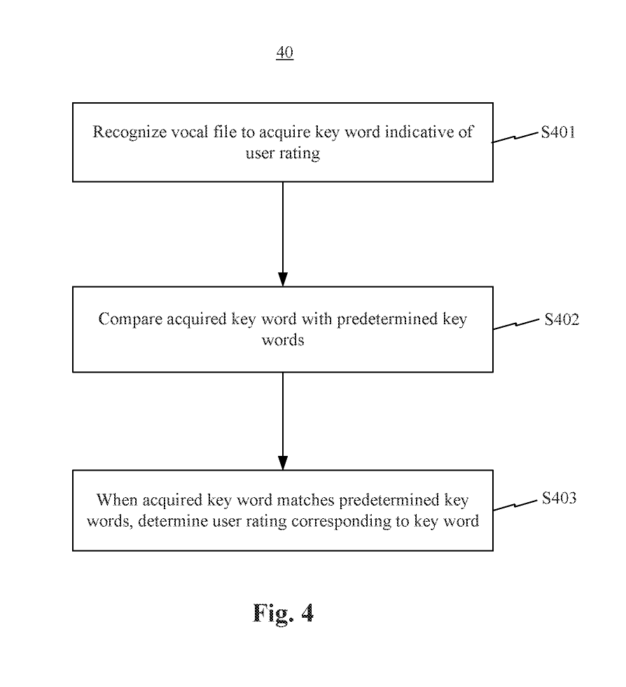

In some embodiments, after acquiring the user ratings based on the target vocal files, the method may further include storing and outputting the user ratings. FIG. 5 is a flow chart showing a method 50 for storing and outputting the user ratings. The method 50 may be performed by the controller 100. Referring to FIG. 5, the method 50 includes steps S501 and S502.

In step S501, the controller 100 is configured to store the user ratings as answers corresponding to the questions, which are included in the audio files of the survey.

In one embodiment, after acquiring responses to the questions presented by the audio files, the controller 100 stores the user ratings as answers to the survey questions to generate a question-answer table in an interface.

In step S502, the controller 100 is configured to output the question-answer table as a survey result to a storage medium.

After generating a question-answer table as a survey result, the controller 100 outputs the survey result. In some embodiments, the survey result can be output to a review interface of the E-commerce merchant correspond to the purchase order so that the other user may view the survey result when purchasing the same item, to improve user experience with the purchase and attract more customers.

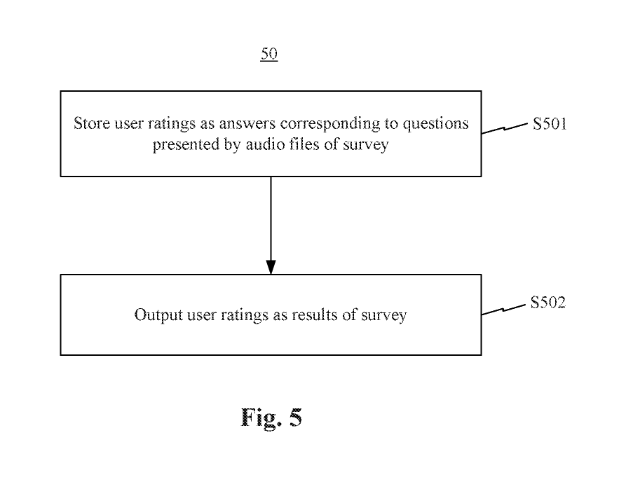

FIG. 6 is a flow chart illustrating a method 60 for making automatic phone calls. The method 60 may be executed by, for example, the interactive audio answering sub-system 300 shown in FIG. 1. Referring to FIG. 6, the method 60 includes steps S601-S606.

In step S601, the interactive audio answering sub-system 300 is configured to receive a call instruction including a user phone number and make a phone call to a terminal, such as the terminal 400, corresponding to the user phone number. The call instruction is generated by the controller 100 after determining that the order status is the target order status. The controller 100 acquires a set of audio files corresponding to the target order status and the user phone number included in the recipient information of the purchase order. The set of target audio files includes one or more audio files. In one embodiment, an audio file corresponds to a question of the survey.

The interactive audio answering sub-system 300 can receive the call instruction including the user phone number, and make a phone call to terminal 400. After a connection to the terminal 400 is established, the terminal 400 is configured to send a response to the interactive audio answering sub-system 300.

In step S602, after receiving the response from the terminal 400, the interactive audio answering sub-system 300 is configured to send a response to the controller 100, indicating a connection is established between the interactive audio answering sub-system 300 and the terminal 400.

In one embodiment, after receiving the response from the terminal 400, the interactive audio answering sub-system 300 can forward the response to the controller 100 so that the controller knows that a connection to the terminal 400 is established and that it is ready to forward audio files to the terminal 400.

In step 603, after the audio broadcasting sub-system 200 plays the set of target audio files in response to a broadcast instruction from the controller 100, the interactive audio answering sub-system 300 is configured to transmit the audio files to the terminal 400.

After the controller 100 receives the response from the interactive audio answering sub-system 300, it controls the audio broadcasting sub-system 200 to play the set of target audio files, which generates sounds. The interactive audio answering sub-system 300 receives and converts the sounds into digital data and forwards the digital data to the terminal 400. The terminal 400 processes the digital data to play a corresponding audio file. This enables the user to listen to the questions of the audio files.

In some embodiments, the target audio files are recorded in digital form stored in the controller 100 or a storage device, such as the interactive audio answering sub-system 300. After the controller 100 receives the response from the interactive audio answering sub-system 300, it forwards and controls the interactive audio answering sub-system 300 to forward the digitized audio files to the terminal 400.

After the terminal 400 plays the set of audio files, in step S604, the interactive audio answering sub-system 300 is configured to receive replies from the terminal 400. The replies include vocal files containing user rating information. In step 605, the interactive audio answering sub-system 300 is further configured to forward the replies to the controller 100 for the controller 100 to determine the user ratings.

In one embodiment, in step 606, the interactive audio answering sub-system 300 is configured to receive a switch instruction from the controller 100 for switching to operator sub-system 800 to manually conduct the survey when the user ratings is the second result (dissatisfactory) or when no vocal file is received. The switch instruction is generated by the controller 100 and forwarded to the interactive audio answering sub-system 300 when no vocal file containing user rating information is received within a predetermined time period, or when the user rating is the second result.

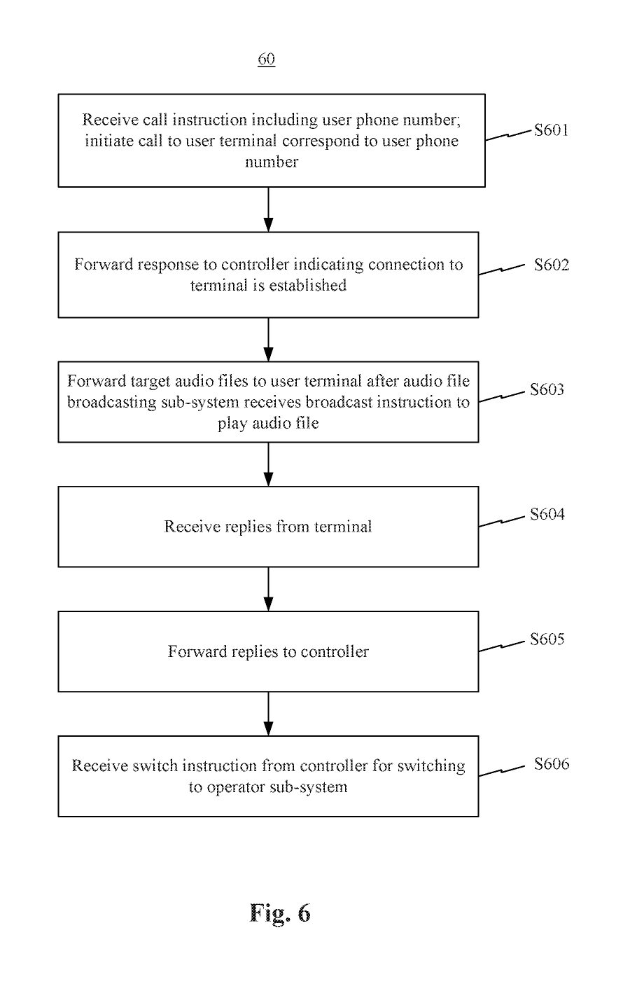

FIG. 7 is a flow chart illustrating a method 70 for making automatic phone calls. The method 70 is executed by the audio broadcasting sub-system 200. Referring to FIG. 7, the method 70 includes steps S701 and S702.

In step S701, the audio broadcasting sub-system 200 receives a broadcast instruction from the controller 100 to play a set of target audio files. When the order status is the target order status, the controller 100 acquires a set of target audio files corresponding to the order status and the user phone number included in the recipient contact information on the order. The controller 100 forwards a call instruction including the user phone number to the interactive audio answering sub-system 300 and receives a reply from the interactive audio answering sub-system 300 indicating a connection is established with the user terminal 400. The controller 100 sends the broadcast instruction to the audio broadcasting sub-system 200. The set of target audio files includes one or more audio files. In one embodiment, an audio file corresponds to a question of the survey. The call instruction prompts the interactive audio answering sub-system 300 to initiate a phone call to the terminal 400 corresponding to the user phone number. A reply is sent by the terminal 400 to the interactive audio answering sub-system 300 when a connection to the terminal 400 is established.

In step 702, the audio broadcasting sub-system 200 plays the set of target audio files. The target audio files can be acquired and sent by the interactive audio answering sub-system 300 to the terminal 400. Details of method 70 are explained in the description in methods 20 and 30 and are not repeated herein.

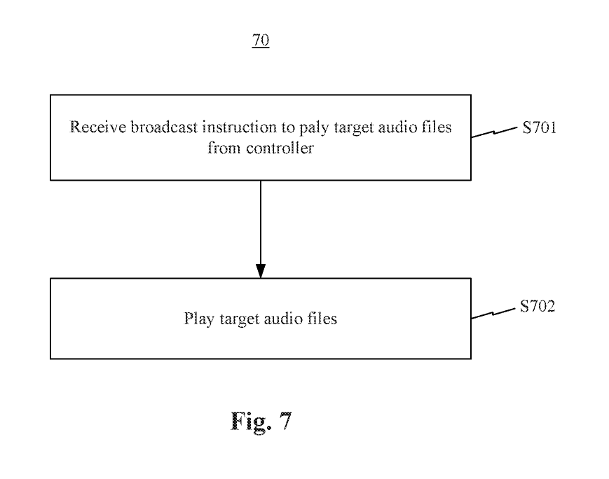

FIG. 8 is a block diagram showing an exemplary controller 80 for making automatic phone calls. The controller 80 executes one or more of the steps of methods 20, 30, 40, and 50 shown in FIGS. 2A, 2B, and 3-5. Referring to FIG. 8, the controller 80 includes a data-acquiring unit 81, a sending unit 82, and a broadcasting unit 83.

The data-acquiring unit 81 is configured to, when the user order status is a target order status, acquire a set of target audio files corresponding to the target order status and user phone number included in the recipient contact information in the user order. The set of target audio files includes one or more audio files. In one embodiment, each of the audio files corresponds to a question in the survey.

The sending unit 82 is configured to forward a call instruction including the user phone number to an interactive audio answering sub-system. The call instruction prompts the interactive audio answering sub-system to make a phone call to a terminal 400 corresponding to the user phone number.

The broadcasting unit 83 is configured to, after a response returned from the interactive audio answering sub-system indicating that a connection to the terminal is established, send a broadcast instruction to an audio broadcasting sub-system to play the set of target audio files. The returned response is a reply sent by the terminal to the interactive audio answering sub-system after a connection therebetween is established. The set of target audio files is played by the audio broadcasting sub-system and forwarded by the interactive audio answering sub-system to the terminal.

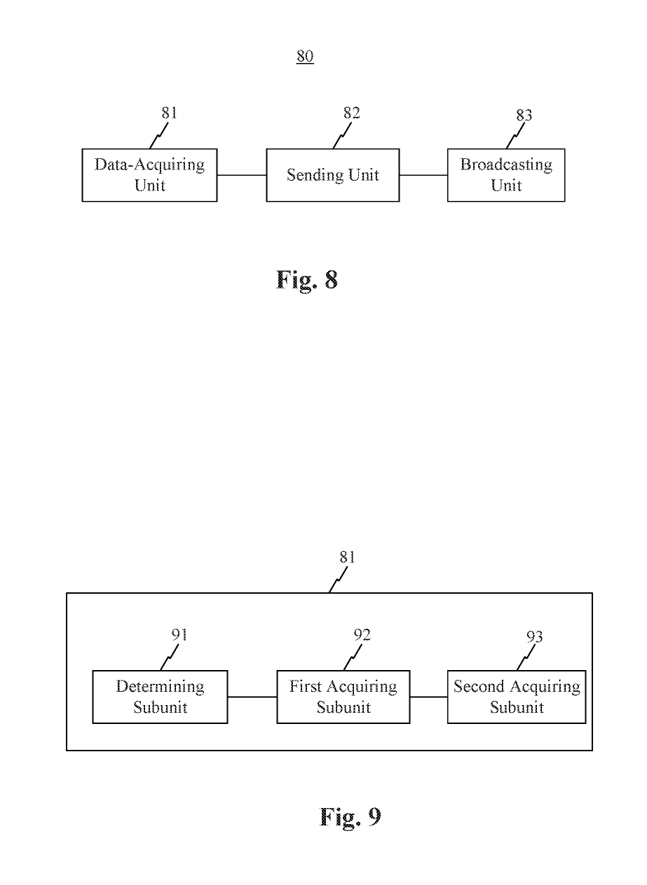

FIG. 9 is a block diagram illustrating configurations of the data acquiring unit 81 shown in FIG. 8. Referring to FIG. 9, the data acquiring unit 81 includes a determining subunit 91, a first acquiring subunit 92, and a second acquiring subunit 93.

The determining subunit 91 is configured to determine that the order status is the target order status. In one embodiment, the determining subunit 91 acquires the user order status from an order sub-system. When detecting that the order status is changed to the target order status, the determining subunit 91 determines that that the order status is the target order status.

The first acquiring subunit 92 is configured to acquire a set of target audio files corresponding to the order status. In one embodiment, the first acquiring subunit 92 acquires the set of target audio files from a storage unit or the audio file control sub-system 600 (FIG. 1), based on a mapping relation between a target order status and target audio files. That is, a set of target audio files correspond to a target order status. After the order status is determined to be the target order status, the first acquiring subunit 92 acquires a set of target audio files corresponding to the target order status.

The second acquiring subunit 93 is configured to acquire the user phone number included in the recipient contact information in the user order. In one embodiment, the second acquiring subunit 93 acquires the recipient contact information from the order sub-system 500 and extracts the user phone number from the recipient contact information. In another embodiment, second acquiring subunit 93 acquires the recipient contact information from a storage unit of the controller 80 or a storage device connected to the controller 80, and extracts the user phone number from the recipient contact information.

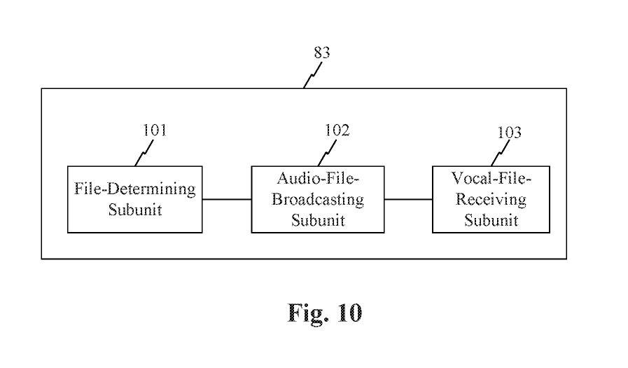

FIG. 10 is a block diagram illustrating configurations of the broadcasting unit 83 shown in FIG. 8. Referring to FIG. 10, the broadcasting unit 83 includes a determining subunit 101, an audio-file broadcasting subunit 102, and a vocal-file receiving subunit 103.

The determining subunit 101 is configured to determine an audio file as a current audio file to be played in the set of target audio files that has not been played yet.

The audio-file-broadcasting subunit 102 is configured to send a broadcast instruction to the audio broadcasting sub-system 200. The broadcast instruction prompts the audio broadcasting sub-system 200 to play the current audio file.

The vocal-file-receiving subunit 103 is configured to receive a current vocal file containing user rating information corresponding to the current audio file.

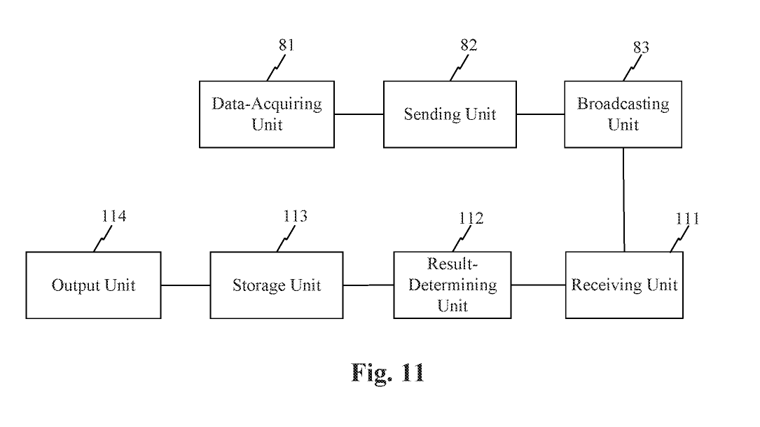

FIG. 11 is a block diagram showing an exemplary controller 110 for automatically making phone calls. The controller 110 executes one or more of the steps of methods 20, 30, 40, and 50 shown in FIGS. 2A, 2B, and 3-5. Referring to FIG. 11, controller 110 includes a data-acquiring unit 81, a sending unit 82, a broadcasting unit 83, a receiving unit 111, a result-determining unit 112, a storage unit 113, and an output unit 114.

The data-acquiring unit 81, the sending unit 82, and the broadcasting unit 83 are the same or substantially the same as those shown in FIG. 8, and the details of their functions and actions are not repeated herein for brevity.

The receiving unit 111 is configured to receive a set of target vocal files including user rating information, transmitted from an interactive audio answering sub-system, such as sub-system 300. The set of vocal files are transmitted from a user terminal, such as terminal 400, to the interactive audio answering sub-system. The vocal files are user responses to questions in the survey acquired by the terminal. The vocal files are played by the terminal for the user to listen. In one embodiment, each of the target vocal files corresponds to each of the audio files.

The result-determining unit 112 is configured to forward the set of target vocal files to a vocal-file-processing sub-system, such as sub-system 700 shown in FIG. 1, and acquire user ratings of the target vocal files transmitted from the vocal-file-processing sub-system. The user ratings are generated by the vocal-file-processing sub-system processing the target vocal files. In one embodiment, the result-determining unit 112 is configured to execute steps to extract the user ratings from the target vocal files.

The storage unit 113 is configured to store the user ratings as answers corresponding to the questions, which are included in the audio files of the survey. The storage unit 113 stores the user ratings as answers to the survey questions and corresponding questions to generate a question-answer table in an interface.

The output unit 114 is configured to output the question-answer table to a medium.

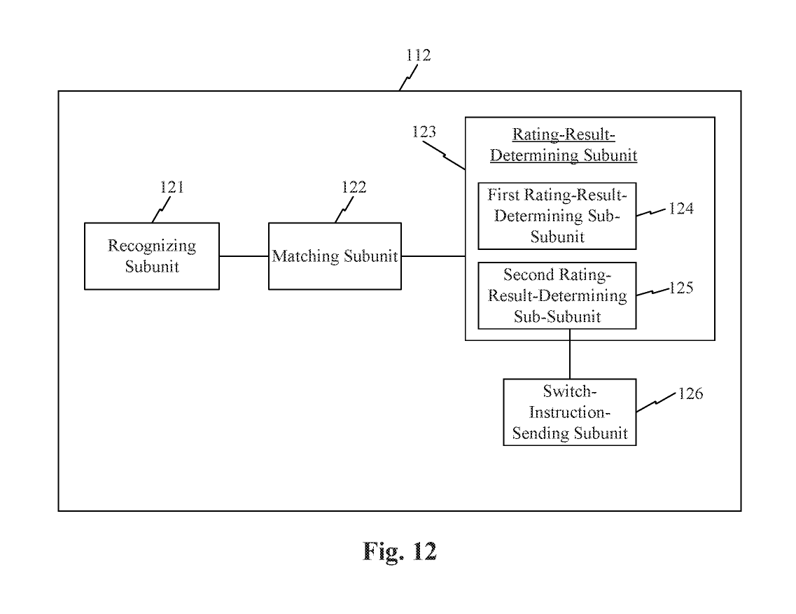

FIG. 12 is a block diagram showing exemplary configurations of the result-determining unit 112 shown in FIG. 11. Referring to FIG. 12, the result-determining unit 112 includes a recognizing subunit 121, a matching subunit 122, and a rating-result-determining subunit 123.

The recognizing subunit 121 is configured to perform sound recognition on the target vocal files and acquire target key words used in the target vocal file that are indicative of user ratings.

The matching subunit 122 is configured to compare and match the target keys words with predetermined key words.

The rating-result-determining subunit 123 is configured to determine the user ratings on the basis that the target key words match the predetermined key words.

The predetermined key words include first key words indicating satisfactory and second key words indicating dissatisfactory.

In some embodiment, the rating result determining subunit 123 includes a first rating-result-determining sub-subunit 124 and a second rating-result-determining sub-subunit 125.

The first rating-result-determining sub-subunit 124 is configured to, when the target key words match the first key words, determine that the user ratings correspond to a first result. The first result indicates that the user is satisfied with purchase experience.

The second rating-result-determining sub-subunit 125 is configured to, when the target key words match the second key words, determine that the user ratings correspond to a second result. The second result indicates that the user is dissatisfied with purchase experience.

In some embodiments, referring to FIG. 12, the result-determining unit 112 further includes a switch-instruction-sending subunit 126 coupled to the second rating-result-determining sub-subunit 125. The switch-instruction-sending subunit 126 is configured to send a switch instruction to an interactive answering sub-system, such as sub-system 300 shown in FIG. 1, when the user ratings is the second result (dissatisfactory) or when no vocal file corresponding a target audio file is received within a predetermined time period. The switch instruction switches the automatic sub-system, e.g., the interactive answering sub-system, to a manual sub-system, such as operator sub-system 800 shown in FIG. 1, where the survey is conducted by a customer service representative.

The illustrated methods, terminals, devices, sub-systems, and systems may be performed by software, hardware, or a combination of software and hardware. For example, they may be implemented in an application-specific integrated circuit (ASIC), general purpose computers, or other hardware devices. In one embodiment, the steps and functions of a unit, subunit, or sub-subunit can be performed by a physical processor. In one embodiment, the steps and their relevant data structures can be stored in a non-transitory computer-readable storage medium, such as a RAM, a magnetic or optical drive, a magnetic disc and the like. In some embodiments, the steps or functions of the present disclosure can be implemented with hardware devices, such as circuits designed to work with the processor to execute the steps or functions.

In some embodiments, all or a portion of the methods can be implemented by computer programs, such as computer instructions, which, when executed by a computer, cause the computer to perform the methods or functions. These computer instructions can be stored in a portable or non-portable, non-transitory computer-readable storage medium, can be transmitted by broadcasting or in a network, and/or can be stored in a memory device of a computing device. A device, sub-system, system, unit, subunit, or sub-subunit consistent with the embodiments of the present disclosure includes a memory device configured to store the computer instructions and a processor configured to execute the instructions to perform the methods or embodiments of the present disclosure.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims. One of ordinary skill in the art will also understand that multiple ones of the above described steps or units may be combined as one step or unit, and each of the above described units may be further divided into a plurality of sub-units. A singular expression of a term in the present disclosure does not exclude that it can be plural. The ordinal numbers used in the present disclosure does not necessarily present the order of the steps or methods. The order of the steps or methods may be modified according to the practical needs.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for making automatic calls, the method being performed by a controller and comprising:
when a user order status is a target order status, acquiring a set of target audio files corresponding to the target order status and a user phone number included in recipient contact information in the user order, the set of target audio files including one or more audio files, each of the target audio files corresponding to at least one question in a survey;
sending a call instruction including the user phone number to an interactive audio answering sub-system, the call instruction prompting the interactive audio answering sub-system to call to a terminal corresponding to the user phone number; and
after receiving a returned response from the interactive audio answering sub-system indicating a connection to the terminal is established, sending a broadcast instruction to an audio broadcasting sub-system to play the set of target audio files.

2. The method of claim 1, wherein the acquiring a set of target audio files corresponding to the target order status includes:
determining the set of target audio files corresponding to the target order status based on a mapping relation between target order status and the set of target audio files.

3. The method of claim 1, wherein the acquiring a set of target audio files corresponding to the target order status includes:
acquiring the set of target audio files returned from an audio file control sub-system, wherein the audio file control sub-system locates the set of target audio files based on the target order status, and information of the target order status is sent to the audio file control sub-system when the order status is determined to be the target order status.

4. The method of claim 1, wherein the acquiring the user phone number included in recipient contact information in the user order includes:
acquiring the recipient contact information in the user order from an order sub-system and extracting the user phone number from the recipient contact information; or
acquiring the recipient contact information in the user order from a storage unit of the controller or a storage device connected to the controller, and extracting the user phone number from the recipient contact information.

5. The method of claim 1, further comprising:
acquiring the user order status from an order sub-system; and
determining that the user order status is the target order status when the user status is changed to the target order status.

6. The method of claim 1, wherein the sending a broadcast instruction to an audio broadcasting sub-system to play the set of target audio files includes:
(A) determining a current audio file from the set of target audio files that has not been played;
(B) sending a broadcast instruction to the audio broadcasting sub-system to play the current audio file; and
(C) repeating the steps (A) and (B) if a current vocal file corresponding to the current audio file is received within a predetermined time period, until no target audio file has not been played.

7. The method of claim 6, further comprising:
receiving a set of target vocal files from the interactive audio answering sub-system, the set of target vocal files including user rating information sent by the terminal toward the interactive audio answering sub-system in response to the set of target audio files, the set of target vocal files corresponding to the set of target audio files.

8. The method of claim 7, further comprising:
forwarding the set of target vocal files including the user rating information to a vocal-file-processing sub-system and acquiring user ratings from the vocal-file-processing sub-system, wherein the vocal-file-processing sub-system processes the set of target vocal files to obtain the user ratings; or
processing the set of target vocal files to obtain the user ratings.

9. The method of claim 8, each of the target vocal files is processed by steps of:
performing sound recognition on a target vocal file to acquire at least one target key word indicative of a user rating;
comparing the at least one target key word with a set of predetermined key words; and
determining a user rating corresponding to the at least one target key word on a basis that the at least one target key word matches one of the predetermined key words.

10. The method of claim 9, wherein the predetermined key words include first key words indicating satisfactory and second key words indicating dissatisfactory, and the method further comprises:
if the at least one target key word matches one of the first key words, determining that the user rating is a first result, the first result indicating that the user is satisfied with purchase experience; and
if the at least one target key word matches one of the second key words, determining that the user rating is a second result, the second result indicating that the user is dissatisfied with purchase experience.

11. The method of claim 10, further comprising:
if receiving no current vocal file for the current target audio file within the predetermined time period or determining that the user rating is the second result, sending a switch instruction to the interactive audio answering sub-system, the switch instruction controlling the interactive audio answering sub-system to switch to an operator sub-system.

12. The method of claim 8, further comprising:
storing the user ratings as answers and the target audio files as questions in a question-answer table, each of the user ratings correspond to one of the target audio files; and
outputing the question-answer table to a storage medium.

13. A method for making automatic calls, the method being performed by an interactive audio answering sub-system and comprising:
receiving a call instruction including a user phone number and making a phone call to a terminal corresponding to the user phone number, the call instruction being generated by a controller when a user order status is a target order status, the controller acquiring a set of target audio files corresponding to the target order status and the user phone number included in recipient contact information in a user order, the set of target audio files including one or more audio files, each of the target audio files corresponding to at least one question in a survey;
sending a response to the controller indicating a connection to the terminal is established after the terminal accepts the phone call; and
transmitting a set of target audio files to the terminal after an audio broadcasting sub-system responds to a broadcast instruction, the broadcasting instruction being forwarded by the controller to the audio broadcasting sub-system.

14. The method of claim 13, further comprising:
receiving a set of vocal files including user rating information from the terminal; and
sending the set of vocal files to the controller.

15. The method of claim 13, further comprising:
receiving a switch instruction from the controller when the controller receives no vocal file corresponding to the target audio files within a predetermined time period or determines that the user rating is indicative of dissatisfaction; and
in response to the switch instruction, switching to an operator sub-system to handle the survey.

16. A method for making automatic calls, the method being performed by an audio broadcasting sub-system and comprising:
receiving a broadcast instruction from a controller to play a set of target audio files, the broadcasting instruction being generated by the controller when a user order status is a target order status, the broadcast instruction being sent by the controller after the controller acquires a set of target audio files corresponding to the target order status and the user phone number included in recipient contact information in a user order, sends a call instruction to an interactive audio answering sub-system, and receives a response from the interactive audio answering sub-system indicating that a connection to a terminal corresponding to the user phone number is established, the set of target audio files including one or more audio files, each of the target audio files corresponding to a question in a survey, the call instruction prompting the interactive audio answering sub-system to make a phone call to the terminal corresponding to the user phone number; and
playing the set of target audio files, wherein the played target audio files are acquired and transmitted by the interactive audio answering sub-system to the terminal.

17. A system for making automatic calls, comprising a controller, an audio broadcasting sub-system and interactive audio answering sub-system coupled to the controller, and a terminal coupled to the interactive audio answering sub-system, the audio broadcasting sub-system and the interactive audio answering sub-system being coupled to each other, wherein:
the controller is configured to, when a user order status is a target order status, acquire a set of target audio files corresponding to the target order status and a user phone number included in recipient contact information in the user order, send a call instruction including the user phone number to the interactive audio answering sub-system, and sends a broadcast instruction to the audio broadcasting sub-system to play the set of target audio files after receiving a returned response from the interactive audio answering sub-system indicating a connection to the terminal is established, the set of target audio files including one or more audio files, each of the target audio files corresponding to a question in a survey;
the interactive audio answering sub-system is configured to receive the call instruction and make a phone call to the terminal corresponding to the user phone number, send the response to the controller after the terminal accepts the phone call, and transmit the set of target audio files to the terminal after the audio broadcasting sub-system responds to the broadcast instruction to play the set of target audio files; and
the audio broadcasting sub-system is configured to receive the broadcast instruction sent by the controller and play the set of target audio files.

18. The system of claim 17, further comprising:
an audio file control sub-system coupled to the controller and configured to locate and transmit the set of target audio files to the controller based on the target order status;
an order sub-system coupled to the controller and configured to determine whether the user order status is the target order status,
wherein the controller acquires the recipient contact information in the user order from the order sub-system and extract the user phone number from the recipient contact information.

19. A device for making automatic calls, comprising:
a data acquiring unit configured to, when a user order status is a target order status, acquire a set of target audio files corresponding to the target order status and a user phone number included in recipient contact information in the user order, the set of target audio files including one or more audio files, each of the target audio files corresponding to a question in a survey;
a sending unit configured to send a call instruction including the user phone number to an interactive audio answering sub-system, the call instruction prompting the interactive audio answering sub-system to call to a terminal corresponding to the user phone number; and
a broadcasting unit configured to, after receiving a returned response from the interactive audio answering sub-system indicating a connection to the terminal is established, send a broadcast instruction to an audio broadcasting sub-system to play the set of target audio files, wherein the returned response is generated and forwarded by the terminal after the terminal answers the call.

20. The device of claim 19, wherein the data acquiring unit includes:
a determining subunit configured to determine that the order status is the target order status;
a first acquiring subunit configured to acquire the set of target audio files corresponding to the order status; and
a second acquiring subunit configured to acquire the user phone number included in the recipient contact information in the user order.
